(19) United States
(12) Patent Application Publication
(10) Pub. No.: US 2010/0011606 A1
(43) Pub. Date: Jan. 21, 2010

(54) Clothes dryer having fragrance supplying module

(76) Inventors: Min-Ji Kim, Changwon (KR); Sang-Hun Bae, Changwon (KR); Chul-Jin Choi, Changwon (KR)

Correspondence Address: MCKENNA LONG & ALDRIDGE LLP, 1900 K STREET, NW, WASHINGTON, DC, 20006, US

(21) Appl. No.: 12/458,595

(22) Filed: Jul. 16, 2009

Related U.S. Application Data
(60) Provisional application No. 61/081,609, filed on Jul. 17, 2008.

(30) Foreign Application Priority Data
Jul. 17, 2008 (KR) 10-2008-0069725

(51) Int. Cl. F26B 19/00; F26B 11/02

(52) U.S. Cl. 34/60; 34/108

(57) ABSTRACT

Disclosed is a clothes dryer including, a main body configuring an outer appearance, a door installed at a front surface of the main body for opening and closing an inside, a drum rotatably installed in the main body, a front supporter disposed in the main body for supporting a front side of the drum, and a fragrance supplying module for supplying a fragrant material into the drum, wherein the fragrance supplying module is mounted at the front supporter in the main body to be reachable by opening the door, and the fragrant material contained in the fragrance supplying module is a solid, liquid or gaseous component, whereby supplement or replacement of the fragrant material can be facilitated, if required, by allowing the fragrance supplying module for spraying fragrance into the drum of the dryer to be installed at a easily reachable position.

### CROSS-REFERENCE TO A RELATED APPLICATION

Pursuant to 35 U.S.C. § 119(a), this application claims the benefit of earlier filing date and right of priority to Korean Application No. 10-2008-0069725, filed on Jul. 17, 2008 and U.S. Patent Application No. 61/081,609, filed on Jul. 17, 2008 the contents of both of which are incorporated by reference herein in their entireties.

### BACKGROUND OF THE INVENTION

1. Field of the Invention

The present invention relates to a clothes dryer, and particularly, to a clothes dryer having a fragrance supplying module capable of spraying fragrance into a drum of the clothes dryer.

2. Background of the Invention

In general, a clothes dryer indicates an apparatus for drying laundry (e.g., clothes) having completely undergone a dehydration process after a washing process, by introducing the laundry into a drum of the clothes dryer, supplying hot blast into the drum and evaporating moisture inside the laundry.

The clothes dryer comprises a drum disposed in the clothes dryer and into which laundry is introduced, a driving motor for driving the drum, a blow fan for blowing air into the drum, and a heating means for heating the air introduced into the drum.

The heating means may use high-temperature electric resistance heat generated by using an electric resistance, or combustion heat generated by combusting gas.

Air having discharged from the drum contains moisture of the laundry inside the drum, thereby changing into high-temperature humid air. According to a method for processing the high-temperature humid air, the clothes drier may be classified. More concretely, the clothes driers may be classified into a condensation type clothes dryer for condensing moisture inside high-temperature humid air by heat-exchanging the high-temperature humid air with external air in a condenser through circulation in the clothes dryer without discharging the high-temperature humid air out of the clothes dryer, and an exhaustion type clothes dryer for directly discharging high-temperature humid air having passed through the drum to the outside.

In the conventional clothes dryer, laundry is dehydrated with an attached state to an inner circumferential surface of the drum. Accordingly, in order to remove wrinkles and to arrange the laundry in a state for facilitation of ironing, has been used a steam supplier for supplying steam into the drum.

However, the conventional clothes dryer has the following problems.

Firstly, in the case of drying laundry by the clothes dryer, the laundry having completely washed by a washing machine, moisture included in the laundry is removed. However, odor of washing water or detergent may remain in the dried clothes, or odor remaining on laundry itself prior to the washing process may remain on the dried clothes after the washing process. This may cause a user's discomfort.

Furthermore, this odor may become more severe when laundry having completely washed stays in the washing machine for a long time without being directly discharged out from the washing machine. So, in order to remove such odor and make a user feel comfortable, fragrance has been supplied into the drum.

However, when a fragrant material emitting fragrance into the drum is completely consumed and thereby needed to be replaced or refilled, since the fragrant material is disposed at a position difficult to be reached, a user may feel inconvenient. Particularly, the fragrant material is disposed on a flow path along which air is introduced into the drum or a top cover. So, inconveniently, screws or other tools should be used to replace or repair the fragrant material.

### SUMMARY OF THE INVENTION

Therefore, to solve the problems of the related art, an object of the present invention is to provide a module for facilitating spraying of a fragrant material in a liquid state into a drum of a dryer during a drying process so as to remove odor from completely dried clothes and giving off fragrance out of the clothes.

To achieve these and other advantages and in accordance with the purpose of the present invention, as embodied and broadly described herein, there is provided a clothes dryer including, a main body configuring an outer appearance, a door installed at a front surface of a main body and configured to open and close an inside of the dryer, a drum rotatably installed inside the main body, a front supporter disposed in the main body and configured to support a front side of the drum, and a fragrance supplying module configured to supply fragrance emitted from a fragrant material into the drum, wherein the fragrance supplying module is mounted at the front supporter so as to be reachable by opening the door.

With such configuration, a user can easily reach the fragrance supplying module so as to be convenient to supplement ore replace a fragrant material. The fragrant material of the fragrance supplying module may be solid or gaseous. The fragrance supplying module may include a cartridge and a cartridge accommodation portion. The cartridge may contain the fragrant material, and be accommodated in the cartridge accommodation portion.

The cartridge of the fragrance supplying module may be detachably accommodated in the cartridge accommodation portion so as to be replaced for reuse when necessary.

The fragrant material of the fragrance supplying module may be liquid. In this case, the fragrance supplying module may include a chamber configured to contain the fragrant material, a pump connected to the chamber, and a nozzle connected to the pump for spraying fragrance. The fragrant material contained in the chamber may be sprayed via the nozzle under the control of a controller of the dryer when necessary. The chamber of the fragrance supplying module may be detachably mounted such that the chamber itself can be replaced when a fragrant liquid has completely been consumed or can be refilled with the fragrant material for use.

The chamber of the fragrance supplying module may be provided with an inlet having a cap for supplementing the fragrant material, such that the cap can be open to supply the fragrant material via the inlet.

In another aspect of the present invention, there is provided a clothes dryer including, a main body configuring an outer appearance, a door installed at a front surface of a main body and configured to open and close an inside of the dryer, a drum rotatably installed in the main body, a front supporter disposed in the main body and configured to support a front side of the drum, and a fragrance supplying module configured to supply fragrance emitted from a fragrant material into the drum. Here, the fragrance supplying module may be disposed at an inner side of the door to be reachable by opening the door.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a perspective view of a clothes dryer in accordance with the present invention;

FIG. 2 is a side sectional view of the clothes dryer of FIG. 1;

FIG. 3 is a perspective view of a steam generator mounted to the clothe dryer;

FIG. 4 is a view showing a front supporter to which a fragrance supplying module is mounted (attached) in accordance with the present invention;

FIG. 5 is a perspective view of the fragrance supplying module of FIG. 4;

FIG. 6 is a view showing a portion of the front supporter to which the fragrance supplying module is mounted;

FIG. 7 is a perspective view showing a fragrant material cartridge and a cartridge accommodation portion; and

FIG. 8 is a view showing a portion where the fragrance supplying module is disposed at a door of the dryer.

### DETAILED DESCRIPTION OF THE INVENTION

Description will now be given in detail of the present invention, with reference to the accompanying drawings.

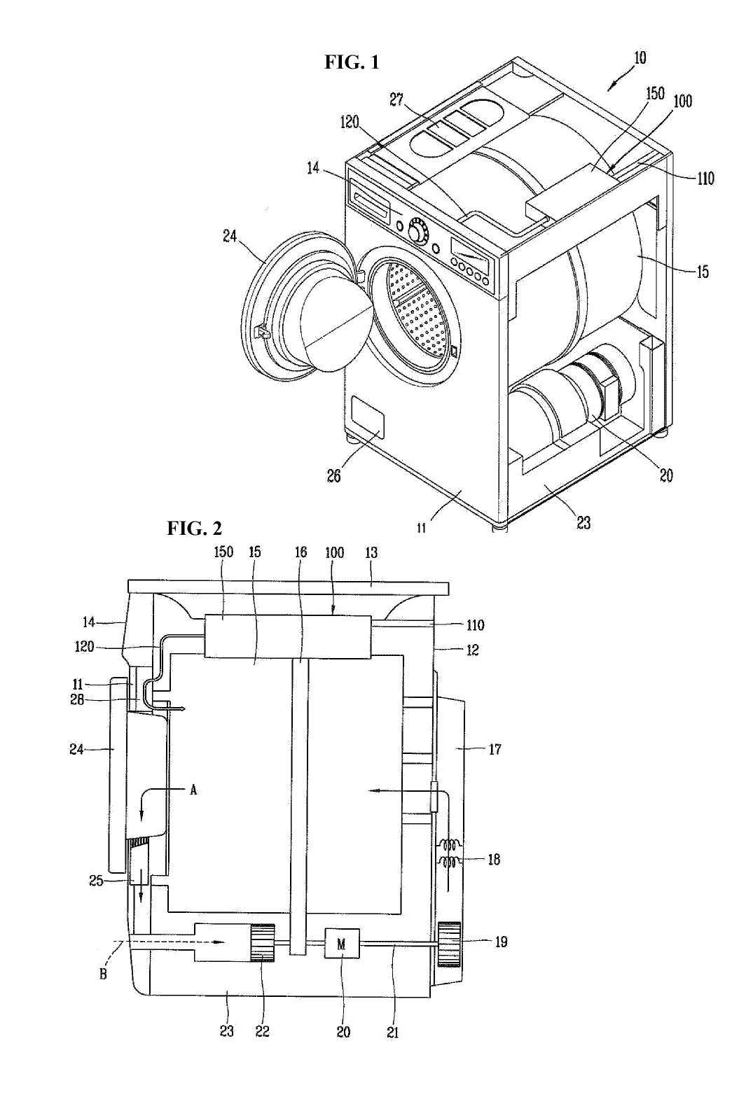

Referring to FIGS. 1 and 2, a clothes dryer 10 according to the present invention comprises a front cover 11, a rear cover 12, a top cover 13, and a drum 15 into which laundry is introduced. The clothes dryer 10 also comprises a front supporter 28 mounted at a rear surface of the front cover 11, for supporting a front opening of the drum 15; a door 24 mounted at a front surface of the front cover 11, for opening and closing an opening of the drum 15; and a control panel 14 disposed at an upper part of the front cover 11, and having each kind of buttons for inputting drying conditions.

Also, the clothes dryer 10 comprises a drying fan 19 for making air inside the drum 15 circulate in the clothes dryer 10, a drying duct 17 for guiding circulation air having passed through the drum 15 by the drying fan 19 to be introduced into the drum 15, a heater 18 disposed in the drying duct 17 for heating air introduced into the drum 15, and a steam generator 100 disposed at an outer side of the drum 15 for generating steam.

Below the drum 15, further comprised are a base 23 having a flow path of circulation air A and a flow path of external air B which performs heat exchange with the circulation air A; a driving motor 20 mounted on an upper part of the base 23 for driving the drum 15; a belt 16 for transmitting a rotation force generated by the driving motor 20 to the drum 15; a cooling fan 22 connected to a motor shaft 21 of the driving motor 20 for sucking indoor air; and a condenser 26 mounted at an inner side of the base 23, for heat-exchanging the external air B with the circulation air A.

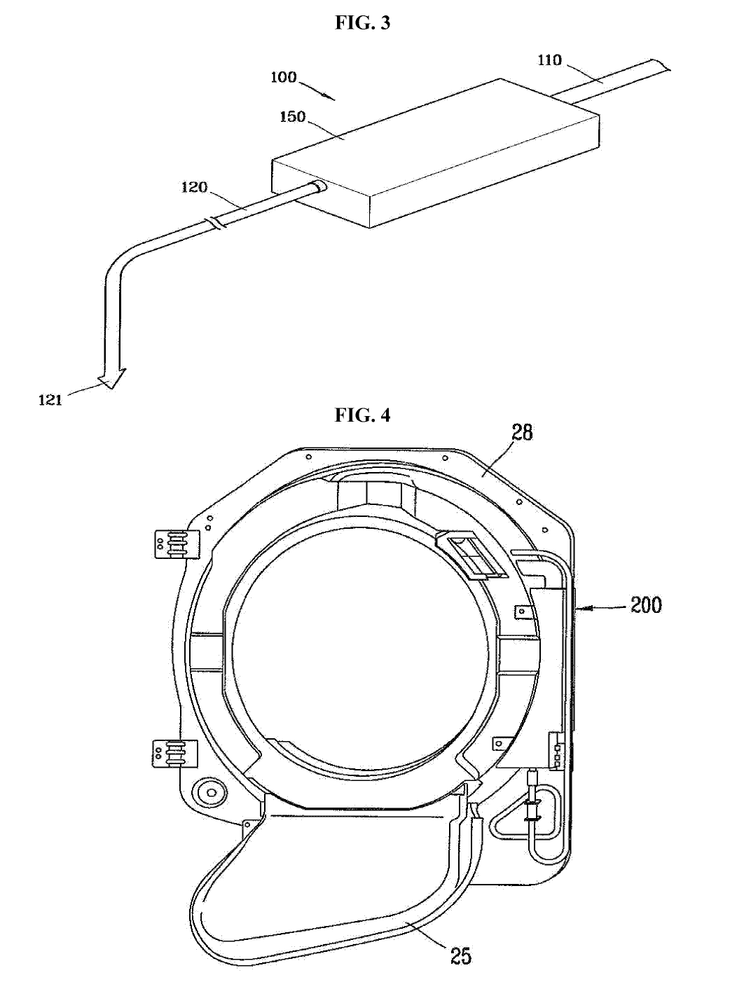

FIG. 3 is a perspective view of a steam generator 100 mounted to the clothes dryer 10.

Referring to FIG. 3, the steam generator 100 includes a water supplying hose 110 for supplying water having a room temperature, a steam generator body 150 for storing water supplied thereto, a heater (not shown) disposed in the steam generator body 150 for heating the stored water, a discharge hose 120 for discharging steam generated from the steam generator body 150, and a steam nozzle 121 connected to the end of the discharge hose 120. Under these configurations, water having supplied to the steam generator body 150 through the water supplying hose 110 is heated by the heater, and then is discharged to the discharge hose 120. And, the discharged steam is sprayed into the drum 15 through the steam nozzle 121.

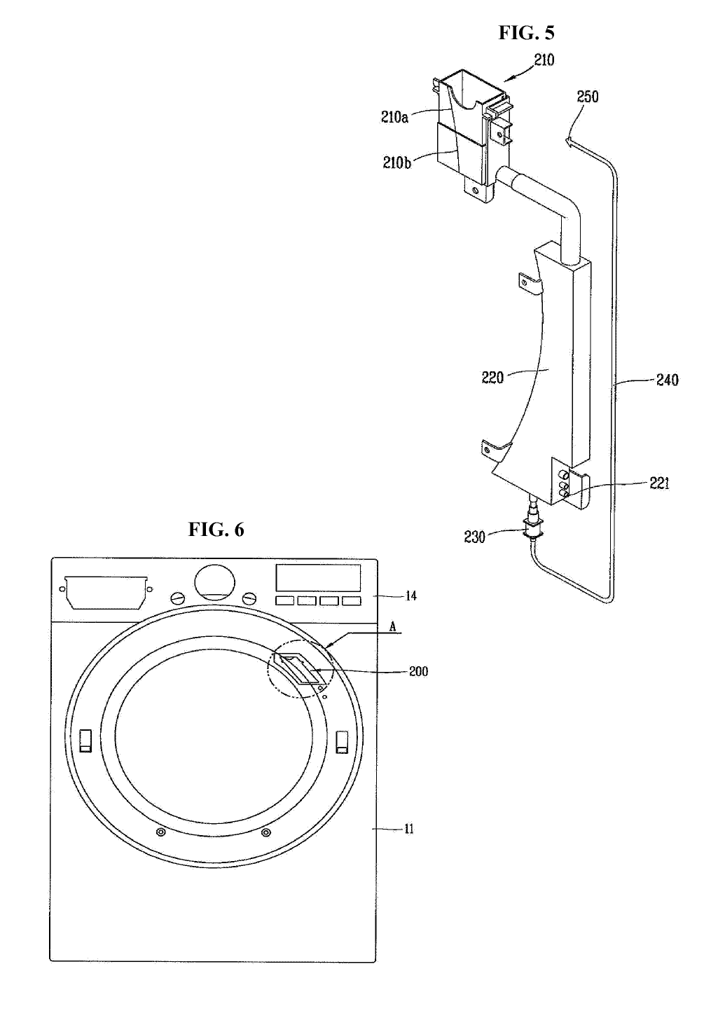

FIG. 4 is a view of the front supporter 28 for supporting a front opening of the drum 15 of the clothes dryer according to the present invention, and FIG. 5 is a perspective view of a fragrance supplying module 200 for supplying fragrance into the drum 15 of the clothes dryer 10.

FIG. 4 shows the shape of the front supporter 28 viewed from the inside of the clothes dryer toward the front surface of the clothes dryer, and FIG. 5 shows the fragrance supplying module 200 of FIG. 4.

Referring to FIG. 4, a filter 25 is mounted below the front supporter 28, thereby filtering lint included in air discharged from the drum 15. The fragrance supplying module 200 is mounted at a side surface of the front supporter 28.

Referring to FIG. 5, the fragrance supply module 200 includes a fragrance injection unit 210, a fragrance storage unit 220 connected to the fragrance injection unit 210, a pump 230 connected to the fragrance storage unit 220, and a nozzle 250 connected to the pump 230 by a tube 240 for spraying fragrance into the drum 15.

The fragrance injection unit 210 is composed of a fixed member 210b and a slide member 210a. The fixed member 210b is fixedly-mounted to the front supporter 28, and the slide member 210a is slidably mounted to the fixed member 210b. Protrusions are formed on both side surfaces of the slide member 210a, and guide members for guiding the protrusions inserted thereto to perform a sliding motion. Accordingly, the slide member 210a may be inserted into the fixed member 210 by a sliding motion, thereby being inserted into the front supporter 28.

A discharge opening is formed at a lower part of the fixed member 210b, and is connected to the fragrance storage unit 220 through a pipe. Under this configuration, when a user is to inject a fragrant liquid into the fragrance storage unit 220, the slide member 210a of the fragrance injection unit 210 is pulled to be protruded from the fixed member 210b, i.e., the slide member 210a is made to be protruded from the front supporter 28. Then, the fragrant liquid is injected into the slide member 210a for supplement.

In the fragrance storage unit 220, may be disposed a level sensor 221 for measuring the amount of a fragrant liquid stored in the fragrance storage unit 220. The level sensor 221 may be an electrode sensor, or a reed switch operated by a magnetic field generated from a permanent magnet and a current-carrying coil. The present invention may be also provided with a means for informing a user that the amount of the fragrant liquid inside the fragrance storage unit 220 is not sufficient. Preferably, the means is installed at the control panel disposed on the front surface of the clothes dryer 10.

FIG. 6 shows an example in which the fragrance supplying module 200 is disposed at a right surface of the front supporter 28; however, it is merely exemplary. Alternatively, the fragrance supplying module 200 may be disposed at a lower side or right surface of the front supporter 28.

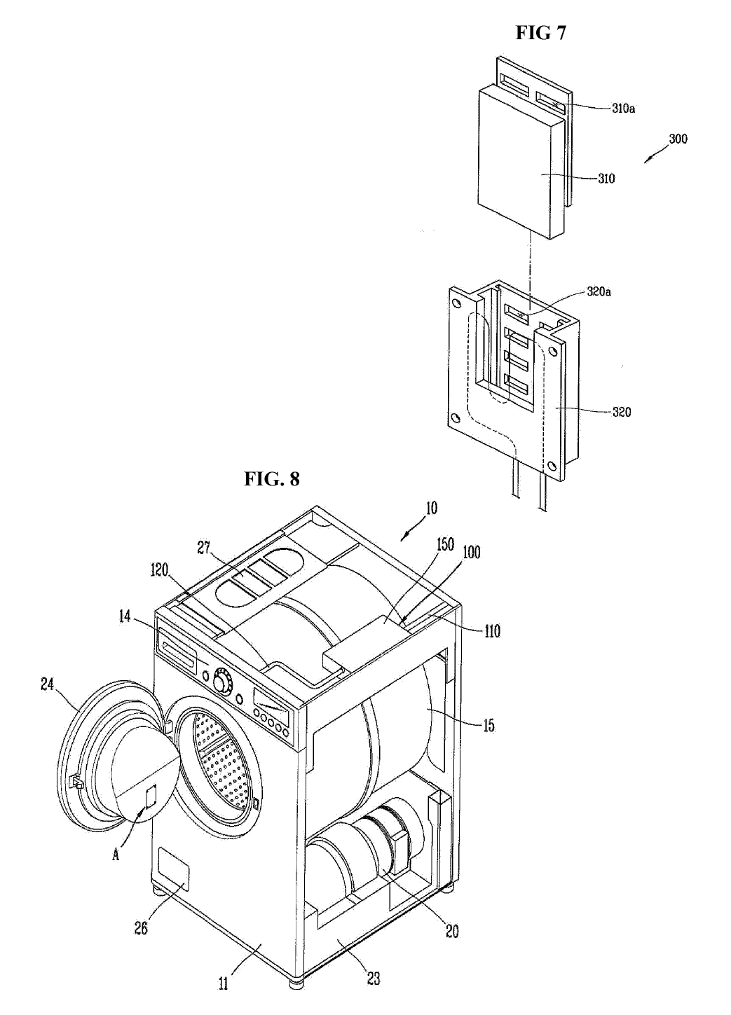

In accordance with another embodiment of the present invention, a fragrant material may be solid or gaseous. FIG. 7 exemplarily shows a fragrance supplying module 300 in the case where the fragrant material is solid or gaseous. The fragrance supplying module 300 according to this embodiment may include a cartridge 310 and a cartridge accommodation portion 320. The cartridge 310 may contains a fragrant material, and the cartridge accommodation portion 320 may accommodate the cartridge 310. Slits 310a may be formed at one surface of the cartridge 310 such that fragrance (i.e., the fragrant material) can be sprayed therethrough. Further, when the cartridge 310 is mounted in the cartridge accommodation portion 320, slits 320a may be formed at a surface of the cartridge accommodation portion 320 corresponding to the surface of the cartridge 310 having the slits 310a. Accordingly, the fragrance sprayed out of the slits 310a of the cartridge 310 can be sprayed into the dryer via the slits 320a of the cartridge accommodation portion 320.

The cartridge 310 and the cartridge accommodation portion 320 may be disposed at the front supporter 28 disposed inside the dryer. If a fragrant material contained in the cartridge 310 has completely been consumed, the cartridge 310 is detached (separated) from the cartridge accommodation portion 320 so as to supplement (refill) the fragrant material or be replaced with another cartridge. Then, the supplemented or replaced cartridge 310 is mounted (attached) to the cartridge accommodation portion 320 for use.

In accordance with another embodiment of the present invention, regarding the fragrance supplying module 300, the cartridge accommodation portion 320 for accommodating the cartridge 310 may be provided with a recess portion (not shown) recessed in the front supporter 28 of the dryer. Here, the fragrance supplying module 300 may be configured such that the cartridge 310 can be inserted for use in the recess portion formed in the front supporter 28 without being provided with a separate accommodation portion for accommodating the cartridge 310, and also be replaced when needed.

FIG. 8 shows that the fragrance supplying module is mounted to the door of the dryer. Similar to the fragrance supplying module being mounted to the front supporter, even when the fragrance supplying module is mounted to the door of the dryer, a user may open the door to supplement (refill) or replace the fragrant material, which makes the user feel convenient. Detailed shape and operation of the fragrance supplying module mounted to the door are the same to those of the fragrance supplying module mounted to the front supporter, and a detailed description thereof will be omitted.

A brief description will be given of a fragrance spraying and drying process in a condensation type clothes dryer 10 according to the present invention with such configuration. First, a user opens the door 24 to put clothes in the drum 15 and then selects a fragrance drying course via an input unit disposed on the control panel 14. Accordingly, water is supplied into the steam generator 100 via the water supplying hose 110. Such water is heated up by a heater disposed inside the steam generator 100. Steam (vapor) generated in the steam generator 100 is introduced into the drum 15 via the steam nozzle 120.

In the meantime, upon a drying process being started, the driving motor 20 is driven. A belt wound on an outer circumferential surface of the drum 15 and the motor shaft 21 is rotated in cooperation with the rotation of the motor shaft 21, and cooperatively the drum 15 is also rotated. Here, the cooling fan 22 and a drying fan 19 both connected to the driving motor 20 are driven together with the driving motor 20. Also, the heater 18 disposed in the drying duct 17 heats up air introduced into the drum 15.

The steam generator 100 may be provided with a case 150, and a heater (not shown) disposed in the case 150 for heating up water inside the steam generator 100, thereby changing into water vapor (steam). The water supplying hose 110 for supplying water is mounted at one side of the steam generator 100, and the discharge hose 120 for discharging vapor evaporated from the inside of the steam generator 100 is mounted at another side of the steam generator 100. The steam nozzle 121 through which steam is injected out is disposed at the end of the discharge hose 120. The steam nozzle 121 may be disposed at a front surface or rear surface of the drum 15 so as to inject steam into the drum 15.

The thusly configured steam generator 100 heats up water supplied via the water supplying hose 110 by the heater, such that the water changes into steam.

The generated steam is introduced into the drum 15 via the discharge hose 120 and the steam nozzle 121, to remove wrinkles on the clothes generated during the drying process and sterilize the clothes.

During the drying process according to the present invention, at the same time of injecting such steam, fragrance is sprayed into the drum 15 of the dryer. In the present invention, a fragrant liquid injected into the fragrance injection unit 210 of the fragrance supplying module 200 is stored in the fragrance storage unit 220. Then, the fragrant liquid is compressed by the pump 230 when necessary, thereby being sprayed into the drum 15 through the nozzle 250 in the form of mists. The time when the fragrant liquid is sprayed may be manually controlled by a user's manipulation of the control panel, or may be automatically controlled by a microprocessor. In the case of the latter automatic control, a user selects his or her desired drying course among a plurality of pre-programmed drying courses on the control panel. According to the selected drying course, the time to spray the fragrant liquid is automatically controlled by a microprocessor.

After repeating the drying process plural times in the dryer, if the fragrant material contained in the fragrance supplying module 200 is completely consumed and needed to be refilled (supplemented), a level sensor, configured as an electrode sensor or magnetic sensor, for measuring an amount of a fragrant material remaining in the fragrance storage unit 220 detects the lack of fragrant material, thereby outputting a signal for notifying the lack of the fragrant material to the user via the microprocessor. When the user recognizes the signal and intends to inject the fragrant material in the fragrance supplying module 200, then the user opens the door and pulls a sliding member of the fragrance injection unit 210, disposed on the front supporter, out of the fixed member. Accordingly, the user is allowed to inject the fragrant material in the liquid state into the sliding member so as to supplement the fragrant material.

For using a cartridge filled with the fragrant material, a fragrance-consumed cartridge is detached from the dryer. The detached cartridge may be refilled with the fragrant material and then re-attached to the dryer. Alternatively, the fragrance-consumed cartridge may be replaced with a new cartridge for use.

With such configuration of the present invention, while drying clothes, the fragrant material is allowed to be sprayed into the drum of the dryer. The fragrant material may be solid, liquid or gaseous. Specifically, the present invention disposes the fragrance supplying module for spraying the fragrant material into the drum of the dryer at an easily reachable position, which facilitates re-supply or replacement of the fragrant material when needed.

The foregoing embodiments and advantages are merely exemplary and are not to be construed as limiting the present disclosure. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. A clothes dryer comprising:
a door installed at a front surface of a main body and configured to open and close an inside of the dryer;
a drum rotatably installed inside the main body;
a front supporter disposed in the main body and configured to support a front side of the drum; and
a fragrance supplying module configured to supply fragrance emitted from a fragrant material into the drum,
wherein the fragrance supplying module is mounted at the front supporter so as to be reachable by opening the door.

2. The dryer of claim 1, wherein the fragrant material of the fragrance supplying module is solid or gaseous.

3. The dryer of claim 2, wherein the fragrance supplying module comprises:
a cartridge configured to contain the fragrant material; and
a cartridge accommodation portion configured to accommodate the cartridge.

4. The dryer of claim 3, wherein the cartridge of the fragrance supplying module is detachably mounted to the cartridge accommodation portion.

5. The dryer of claim 1, wherein the fragrant material of the fragrance supplying module is liquid.

6. The dryer of claim 5, wherein the fragrance supplying module comprises:
a chamber configured to contain the fragrant material;
a pump connected to the chamber; and
a nozzle connected to the pump for spraying fragrance.

7. The dryer of claim 6, wherein the chamber of the fragrance supplying module is detachably disposed.

8. The dryer of claim 6, wherein the chamber of the fragrance supplying module is provided with an inlet having a cap.

9. A clothes dryer comprising:
a door installed at a front surface of a main body and configured to open and close an inside of the dryer;
a drum rotatably installed inside the main body;
a front supporter disposed in the main body and configured to support a front side of the drum; and
a fragrance supplying module configured to supply fragrance emitted from a fragrant material into the drum,
wherein the fragrance supplying module is disposed at an inner side of the door to be reachable by opening the door.

10. The dryer of claim 9, wherein the fragrant material of the fragrance supplying module is solid or liquid.
